(19) United States
(12) Patent Application Publication
(10) Pub. No.: US 2026/0237073 A1
(43) Pub. Date: Aug. 13, 2026

(54) SYSTEM AND METHOD FOR CROPPING IMAGES

(71) Applicant: Xerox Corporation, Norwalk, CT (US)

(72) Inventors: William David NOTOVITZ, Webster, NY (US); Jason ROY, Ontario, NY (US); Abhilash Ramachandrakurup SUDHARMANI, Thiruvananthapuram (IN)

(73) Assignee: Xerox Corporation, Norwalk, CT (US)

(21) Appl. No.: 19/049,553

(22) Filed: Feb. 10, 2025

(51) Int. Cl. G06T 7/10; G06T 1/60

(52) U.S. Cl. CPC G06T 7/10; G06T 1/60; G06T 2207/20132

(57) ABSTRACT

A system and method for processing an input image provide for cropping of the input image when the input image is larger, in a process direction, than an output image to be generated from the input image. The method includes determining a first location within the input image corresponding to a first line of the output image to be generated and instructing a Direct Memory Access (DMA) controller to begin reading the input image at the first location, without reading at least some of the preceding image data. The DMA controller reads image data of the input image from data memory starting at the first location. Image data read by the DMA controller from the data memory starting at the first location is received by a crop component and the output image is generated from the image data received.

### BACKGROUND

The following relates to the data processing, compression, transfer, and related arts. It finds particular application in the acquisition, compression, cropping, and storage of images during printing, facsimile transfer, and related tasks, and is described with particular reference thereto.

Processing of input documents is widely used in operations such as printing photocopying, scan-to-electronic file operations, and facsimile transmissions. A printing device, such as a printer or a multifunction device, receives input images from an image input device, such as a scanning device or client computing device, in a page description language (PDL) such as portable document format (PDF), PostScript, Scalable Vector Graphics (SVG), or the like and processes the image prior to printing.

To facilitate extensive reading and writing of image data to be printed by a printing device, direct memory access (DMA) is often used for transferring the image data between a host device, such as system memory of a machine controller of the printing device, e.g., a central processing unit (CPU) and an output device, such as a printer. The image data may be transferred by the DMA controller to/from the system memory, which may be in the form of a Field Programmable Gate Array (FPGA) or an Application-Specific Integrated Circuit (ASIC). DMA transfer does not involve the CPU's processor, allowing for rapid transfer of large amounts of image data between the FPGA or ASIC of the host device and the output device, leaving the CPU processor free to perform other operations, such as image manipulation (e.g., image rotation, scaling, and format conversion), and control of a marking engine.

During printing, a full image is received by the machine controller and stored in its memory. For an image that is larger than the paper to be used in printing, it may be automatically cropped when it reaches the printing device in order to fit the paper size. For example, an 11″×17″ image may be cropped to fit on 8½″×11″ paper. However, the DMA transfer time may be longer, in some cases, than the time allocated to print each page. As a result, when a second page arrives to be printed, the print data may not yet be available, causing a printer fault.

Described herein is a system and method for transferring image data which reduces the amount of data transferred by the DMA controller, based on the cropping to be performed.

### INCORPORATION BY REFERENCE

The following references, the disclosures of which are incorporated herein by reference in their entireties, are mentioned:

US20090002761A1, published Jan. 1, 2009, entitled PREDICTIVE DMA DATA TRANSFER, by Louis Ba La, et al., describes a compression and storage device including a compressor to compress data, a CPU to control storage of the compressed data and to perform at least one additional task, an electronic memory organized as storage blocks each having a storage block size, and a direct memory access (DMA) engine which operates autonomously from the CPU to transfer a current transfer block of compressed data into one or more storage blocks of the electronic memory, and a transfer block size estimator which selects a transfer block size for the current transfer block based on previous DMA transfers of compressed data.

US20170124678A1, published May 4, 2017, entitled IMAGE PROCESSING APPARATUS AND METHOD, by Yong-Bae Song, describes an image processing apparatus which includes memory and first and second image processors configured to perform image processing operations on image data. The apparatus has two operational modes: in a first mode data is transferred from the first image processor to the second image processor through a signal line directly connecting the first processor and the second processor without accessing the memory, and in a second mode, image data is transferred indirectly, via the memory.

### BRIEF DESCRIPTION

In accordance with one exemplary embodiment, a method for processing an image includes, for an input image that is larger, in a process direction, than an output image to be generated from the input image, with a crop component, determining a first location within the input image corresponding to a first line of the output image to be generated. The first location is provided to a direct memory access (DMA) controller which is configured for reading image data of an input image from data memory starting at a provided location. With the crop component, receiving image data read by the DMA controller from the data memory starting at the first location and generating the output image from the image data received.

In other aspects of this embodiment:
The input image is a raster image and the first location is identified as a byte within a sequence of bytes of the raster image.
The image data preceding the first location is not read by the DMA controller from the data memory.
The method further includes, with the crop component, determining a second location within the input image corresponding to a last line of the output image to be generated and when the image data received by the crop component has reached the second location, signaling to the DMA controller to stop reading the image data from the data memory.
At least some of the image data after the second location is not read from the data memory by the DMA controller.
The method further includes requesting a host processor to relinquish control of a data bus to the DMA controller, the DMA controller thereafter transferring the image data read by the DMA controller via the data bus independently of the host processor.
The image data read by the DMA controller is received by the crop component, the crop component being configured for further cropping the image data to generate the output image.

The input image is stored in a set of blocks in the data memory, each block being associated with a respective descriptor, and wherein the DMA controller is configured for identifying a sequence of the set of blocks to read, based on the descriptors.
The DMA controller is configured for identifying a first of the blocks from the descriptors and, if the identified first location is not within the first block, proceeding to a second of the blocks without reading the first block.
Each of the descriptors identifies a respective starting byte and a respective ending byte of the image data stored in the respective block.
The DMA controller and the crop component are located on a custom hardware device and the host processor is located on a host computing device, host computing device being linked to the custom hardware device by the databus.
In another aspect, a printing system is configured for performing the method described above and printing the output image.
In another aspect, a computer program product includes a non-transitory recording medium storing instructions, which when executed on a computer, causes the computer to perform the method described herein.

In accordance with another embodiment, an image processing system includes data memory which stores an input image to be processed, the input image including image data; a direct memory access (DMA) controller configured for reading the image data from the data memory; and a crop component. The crop component executes instructions for: determining a first location in the input image, the first location corresponding to a first line of an output image to be generated from the input image, the output image being smaller, in a process direction, than the input image; providing the first location to the DMA controller; receiving image data read by the DMA controller from the data memory starting at the first location; and generating the output image from the received image data.

In various aspects of this embodiment:
The input image is stored in a set of blocks in the memory, each block being associated with a respective descriptor, and wherein the DMA controller is configured for identifying a sequence of the set of blocks to read, based on the descriptors.
The DMA controller is configured for identifying a first of the blocks from the descriptors and, if the identified location is not within the first block, proceeding to a second of the blocks without reading the first block.
The crop component is configured for determining a second location within the input image corresponding to a last line of the output image to be generated and wherein when the image data received from the DMA controller has reached the second location, the crop component signals to the DMA controller to stop reading the image data from the data memory.
The system further includes a source of the input image which outputs the input image.
The host processor implements an image processing component which image processes the input image.
The system further includes a graphical user interface which provides for a user to select a crop option from a plurality of crop options, the plurality of crop options including an automated crop option, wherein when the user selects the automated crop option, the host processor requests the crop component to crop the input image.
The system further includes a marking device which prints the output image.

In accordance with another embodiment, an image processing system includes a memory which receives an input image to be processed, the memory including a set of blocks, image data of the input image being partitioned into a plurality of the blocks, each of the blocks being associated, in memory, with an address which enables the image data within the block to be identified. A crop component is configured for generating an output image from the input image. A DMA controller is configured for reading the image data in each of the blocks and transferring the read image data to the crop component, the DMA controller being configured for implementing instructions from the crop component which cause the DMA to skip from a first of the blocks to a second of the blocks, without reading the image data in the first block. A marking device receives the output image and renders the output image on a marking medium.

### BRIEF DESCRIPTION OF THE DRAWINGS

FIG. 1, which is split into FIGS. 1A and 1B for ease of illustration, is a functional block diagram of an image processing system in accordance with one aspect of the exemplary embodiment;

FIG. 2 is a schematic diagram (not to scale) illustrating cropping of an input image; and

FIG. 3, which is split into FIGS. 3A and 3B for ease of illustration, is a flow chart illustrating an image processing method in accordance with another aspect of the exemplary embodiment.

### DETAILED DESCRIPTION

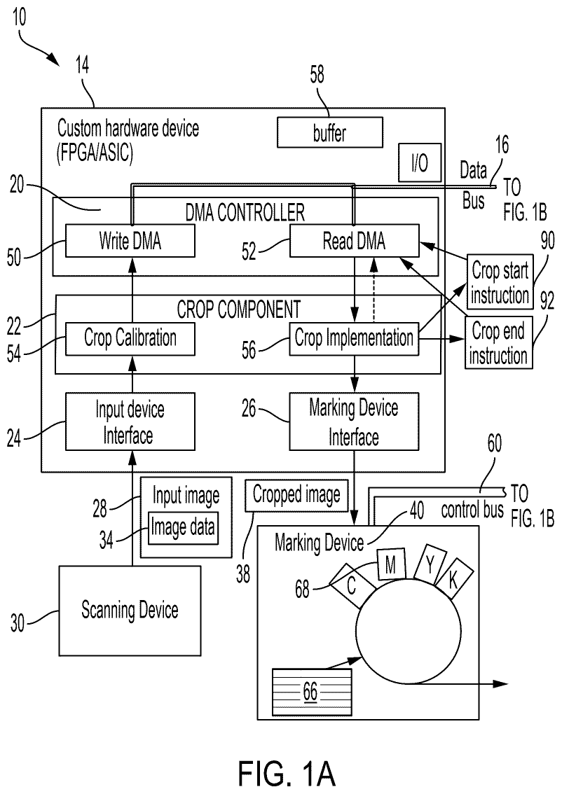

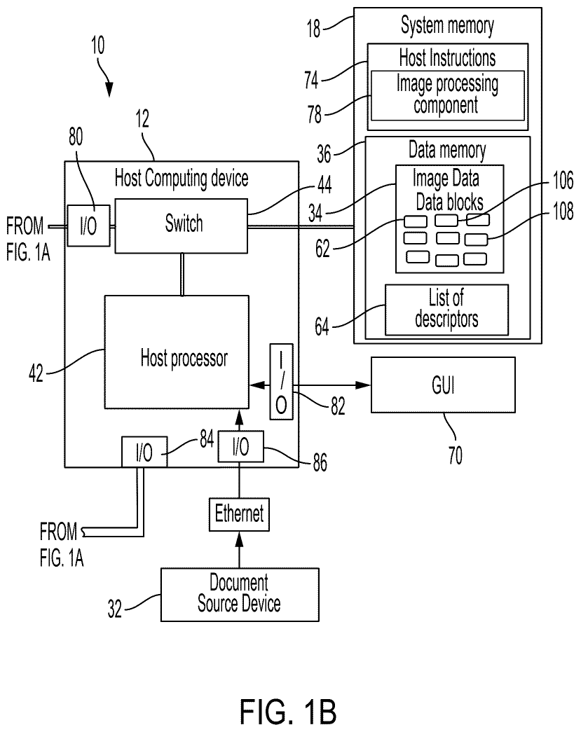

With reference to FIG. 1, which is split into FIGS. 1A and 1B for ease of illustration, an image processing system 10, such as a printing device, includes one or more computer processing devices, such as a host computing device 12, such as an Intel® processor or other CPU, and a custom hardware computing device 14, such as a Field Programmable Gate Array (FPGA) or an Application-Specific Integrated Circuit (ASIC) device. A data bus 16, such as a Peripheral Component Interconnect (PCI) bus or advanced extensible interface (AXI) bus, allows data transfer between the custom hardware device 14 and system memory 18. The system memory 18, such as DRAM, may be incorporated in, or otherwise accessible to, the host computing device 12.

The custom computing device 14 is preprogrammed to incorporate a direct memory access (DMA) controller 20, a crop component 22, an input device interface 24, and an output device (e.g., marking device) interface 26.

The input interface 24 receives a digital input image 28 from an external device, such as a scanning device (scanner) 30. Alternatively, a digital input image 28 is received from an external computing device 32, such as a client computing device, e.g., a PC, laptop, smartphone, server computer, or the like. The input image 28 includes image data 34. In the case of an image received from a computer, the image data may include text, graphics, pictures, and the like, in any suitable format, such as a PDF file. In the case of an image received from a scanner, the image data 34 may be a stream of pixels of different colors (or monochrome shades of grey). For convenience, the term input image is also used to refer to images that have undergone image processing in order to render them suitable for printing.

In the case of a scanner, the scanner 30 serially outputs packets of the image data 34 (e.g., scan line or a sequence of pixels, typically less than a scan line). The crop component 22 may be preconfigured to operate with a specific type of scanner so that the crop component can assign the stream of pixels to lines of image data.

Irrespective of the format of the image 28, the received image data 34 is stored in data memory 36. The data memory 36 may be a designated part of the system memory 18.

The output interface 26 outputs a cropped image 38 to an output device 40, such as a marking device. The cropped image 38 is generated at least in part, by the DMA controller 20, which is instructed, by the crop component 22, to ignore (i.e., not to read) some of the image data 34 from the data memory 36.

The host computing device 12 includes a host processor 42 and a switch 44. The switch allows control of the data bus 16 to be temporarily transferred from the host processor 42 to the DMA controller 20. The DMA controller 20 is configured to transfer packets of image data 34 to/from the data memory 36 of the host computing device 12, via the data bus 16. When reading image data, the DMA controller 20 is instructed, by the crop component 22, to transfer a portion (less than all) of the image data 34 of the input image 28 from the data memory 36 to the crop component 22, effectively cropping the forward edge and/or trailing edge of the image. As a result, the quantity of image data 34 which is read and transferred to the crop component 22 is reduced and the time for the reading and transfer of the image data is correspondingly reduced. This allows processing of the image data 34 to be completed more efficiently. As a result, the time taken for outputting a cropped image 38 to the marking device 40 is reduced.

The DMA component 20 receives/sends image data 34 to and from the crop component. The illustrated DMA controller 20 includes a write DMA component 50 and a read DMA component 52. The illustrated crop component 22 includes a crop calibration component 54 and a crop implementation component 56. The crop calibration component 54 receives input image data 34 from the scanner interface 24 (e.g., as a stream of pixels) and may perform minimal initial processing on the image data 34 (e.g., increasing the darkness of light pixels by applying a formula to the pixel color values), without changing the number of pixels. The crop calibration component 54 then sends the stream of processed pixels to the write component 50 of the DMA controller for writing to data memory 36. The read component 52 of the DMA controller receives instructions from the crop implementation component 56 of the crop component and reads image data 34 from the data memory 36 in accordance with the instructions. The received image data is optionally pre-processed by the host processor 12 while the image data is in data memory 36.

The custom computing device 14 may include a small buffer 58 for temporarily storing small amounts of the image data 34 during processing by the DMA controller 20 and crop component 22. For example, the buffer may store image data for less than a scan line, e.g., at least 100 pixels, and/or up to 500 pixels, allowing the DMA controller to send/retrieve a packet of pixels to/from data memory 36, rather than transferring one pixel at a time.

The number of pixels in each scan line (for each color separation) of the input image 28 is programmed into the crop component 22. For example, each scan line of an input image 28 may include 7600 pixels in the cross-process direction for each color separation. The crop implementation component 56 determines the number of pixels, if needed, to be cropped from ends of each line. Process direction cropping is performed substantially by the read DMA component 52 of the DMA controller, based on instructions from the crop implementation component 56, as described in further detail below.

The data bus 16 is generally under the control of the host processor 12 but can also be controlled by the DMA controller 20. Specifically, the DMA controller 20 requests control of the data bus 16 when one or more packets of image data 34 is/are to be transferred between the data memory 36 and the custom computing device 14, via the data bus 16. When the host processor 12 receives a request from the DMA controller 20, it relinquishes control of the data bus 16, by actuating the switch 44. The DMA controller then reads or writes one or more memory bytes, driving the address, data, and control signals as if it were itself the host processor 12. Once the data transfer r is complete, the DMA controller 20 relinquishes control of the data bus 16 to the host processor 12. The host processor can then remove its DMA acknowledge signal and resume control of the data bus 16. While the data transfer is in progress, the host processor may be able to perform other operations, such as controlling the marking device 40, e.g., via a separate control bus 60 or other wired or wireless connection.

In one embodiment, the image data 34 for an input image 28 may be stored as a set 62 of image data blocks, each block having an associated descriptor, which is stored in a list 64 or other data structure. The descriptor identifies an address of the block in data memory 36 and a block size. For a rasterized image 28, the descriptor allows the respective start and end bytes in the raster to be matched to a specific one of the image data blocks 62 where that part of the image is stored. Each byte includes a fixed number of bits, such as 8 or 16 bits.

The illustrated output device 40 is or includes a marking device, which is configured for rendering processed digital images 38 (cropped images) on print media 66, such as paper, using one or more marking materials 68, such as inks or toners. Exemplary marking devices include laser (xerographic) and inkjet marking devices. A dryer or other fixing component may be positioned downstream of the marking device, which affixes the printed image more permanently to the sheet, e.g., using one or more of pressure and heat or other radiation, e.g., UV radiation. In other embodiments, the output device 40 is or includes a facsimile device, which is configured for outputting the cropped digital image(s) 38 to a remote facsimile machine.

A user interface 70, such as a graphical user interface (GUI), in communication with the host processor, allows a user to make selections for printing the input image(s) 28 on the print media, such as print media size, whether to enable an automated crop function of the crop component 22, and the like. In one embodiment, the GUI 70 is generated on a screen of the associated client computing device 32. Communications via the UI may be in the form of text, graphics, sounds, haptic signals, combinations thereof, or the like. The user may use the GUI, or other user input device, to specify widths of one or more of the margins when the cropped image is printed. Together with the specified print media size, this allows the crop component to determine maximum length and width dimensions of the cropped image 38, when the automated crop function is selected by a user (or by default).

The host processor 12 executes software instructions 74 stored in memory, such as system memory 18. The software instructions may include one or more image processing components 78, which process the input image(s) 28 prior to cropping. These components are known in the art and may include components for removal of scanner-introduced artifacts, such as image noise caused by flecks of dust or scratches on the scanner bed, banding noise (e.g., scanner streaks), components for identifying a text image and converting each of the pixels to white or black, smoothing images detected to be pixels, and the like. The result is a print-ready input image.

One or more input/output (I/O) devices 80,82,84,86 may be provided which allow the host computing device 12 to communicate with external devices, such as the document source 32, the output device 40 and the GUI 70, via wired or wireless links 60, 88, such as a control bus, ethernet, or other computer network. In other embodiments, one or more of the components 14, 18, 32, 70, may be located and accessed remotely, e.g., on a server computer.

The exemplary custom hardware device 14 includes memory which stores software instructions for implementing the DMA controller 20 crop component 54, input device interface 24, and marking device interface 26. A processor executes the instructions. In one embodiment, the memory includes Block Random Access Memory.

The DMA controller 20 may include a byte counter which increments a number of the bytes read by the DMA controller from the input image 28. In the absence of contrary instructions from the crop implementation component 56, the read DMA component 52 reads the image data sequentially, starting with the first byte. The DMA's instructions enable the DMA controller to receive instructions, such as a crop start instruction 90 and/or a crop end instruction 92 from the crop implementation component 56. One or both of the instructions 90,92 causes the DMA controller 20 to transfer less than all of the image data 34 from data memory 36 to the crop component 22. The DMA buffer 58 may temporarily store image data 34 to be transferred and/or the descriptors which point to the image data blocks 62 to be transferred.

The crop start instruction 90 indicates the amount of data to be skipped from the beginning of the image data 34 of the input image 28. For example, a crop start parameter may include a reference to one of the bytes in the image raster which may be located within a line of bytes that lies after the leading edge of the input image. The crop end instruction 92 indicates that the remaining image data 34 can be skipped since the crop component has received sufficient image data to generate the cropped output image 38.

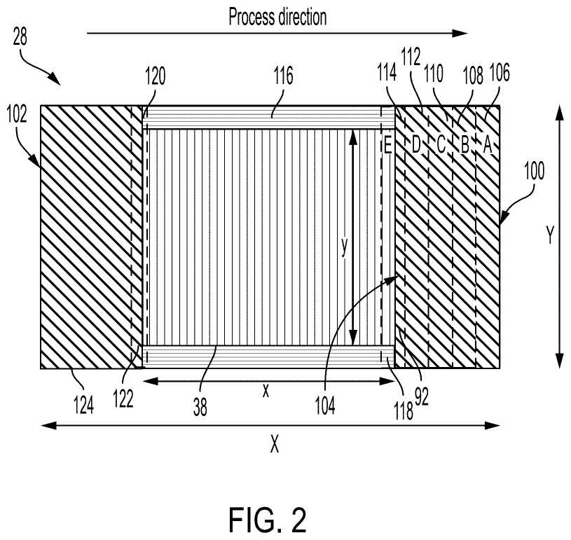

For example, as illustrated in FIG. 2, the input image 28 may have a length X in the process direction and a width Y in the cross-process direction. The crop implementation component 56 of the crop component 22 may determine that the image 28 should be cropped to achieve a smaller size output image 38 of dimensions x,y. The crop component sends the crop start instruction 90, e.g., the number of bytes (=scan lines×bytes per line), that need to be cropped from a leading edge 100 of the image 28, to the read component 52 of the DMA controller 20. The crop component 22 may also be configured to crop image data from a trailing edge 102 of the input image 28 by sending the crop end instruction 92 to the read component 52.

If the input image 28 is stored as one single block in data memory 36, the DMA controller 20 adjusts the DMA start address to read from the first non-cropped line 104 (<start address>+scan lines×bytes per line).

Alternatively, a scatter-gather methodology may be employed, in which the input image data 34 is partitioned into a set 62 of two or more blocks 106, 108, 110, 112, 114, etc., which are illustrated sequentially on the image 28 for ease of description. In this embodiment, the linked list of descriptors 64 contains the addresses and block sizes of where each portion of the image 28 is stored in data memory 36. The read component of the DMA controller 20 reads each descriptor in turn, starting with the first descriptor, which is denoted A, for a first block 106. The first block 106 generally contains image data of the first few lines (e.g., two, five, or ten lines, or more) of the image, starting at the leading edge 100. This block would normally be read first in a conventional DMA process. However, in the present system and method, if the block size is less than the number of bytes Z to be cropped, the DMA controller skips to the descriptor B for the next block 108, without reading the data in block 106. The DMA controller 20 keeps track of the number of bytes of the input image that have been skipped. The DMA controller continues reading descriptors while the block size is less than the remaining bytes to be cropped. For example, the blocks 106, 108, 110, 112 with linked descriptors A, B, C, and D in FIG. 2 will be skipped. However, since block 114 with linked descriptor E is not less than the remaining bytes to be cropped, data will start being read from the address of that block, adjusted for the remaining bytes to be cropped. The DMA controller 20 thus starts sending data, from data memory 36, via the data bus 16, to the crop component 22 when it reaches the line corresponding to the leading edge 104 of the cropped image 38.

The implementation component of the crop component 22 is modified to assume that the first data sent by the DMA controller 20 is at the first non-cropped line. In effect, the DMA controller performs the leading edge cropping, not the crop component 22. The crop component 22 performs further processing on the lines of data received from the DMA controller, such as cropping regions 116, 118, to reduce the width of the image from Y to y. The cropped data for the output image 38 is progressively output to the marking device 40, e.g., as a sequence of lines of image data.

While processing the image data 34, the crop component 22 keeps a track of the data it has been sent by the DMA controller 20. When the crop component determines that it has reached a line corresponding to a trailing edge 120 of the cropped image 38, the crop component sends a crop end signal 92, such as crop_done, to the DMA controller 20. The read component of the DMA controller will complete its current operation, e.g., sending the current line of image data to the crop component, and end. As a result, a minimal amount (if any) of the trailing edge crop data 122 will be read by the DMA controller 20. The crop component handles the cropping of the portion 122 of trailing edge crop data it receives. Data in the remaining portion 124, between the last data sent 122 and the trailing edge 102 of the image 28 is not read by the DMA controller, and thus is not sent to the crop component 22.

As a result, a significant amount of time is saved. First, the DMA controller 20 does not need to read lines adjacent to one or both of the leading and trailing edges 100, 102 of the image 28 that will not form a part of the output image 38. Second, the time the DMA controller needs to control the data bus 16 for transferring the read image data 34 to the crop component is reduced. This frees up the data bus 16 quicker for use by the host processor 12. Third, the crop component 22 has less data to crop and can output the cropped image 38 more quickly to the marking device 40. Overall, the time taken to generate and output a cropped image 38 to the marking device can be reduced significantly, as compared to a conventional process in which the DMA controller reads every line of data.

As an example, for an 11″×17″ input image 28, the full image is processed and stored in data memory 36. Depending on the image resolution, the image size may be approximately 64 MB. If the image 28 is to be cropped to be printed on 8½″×11″ paper, the resulting output image 38 may be approximately 32 MB in size. Thus, approximately 32 MB of the image is cropped. In the case of duplex printing, the trailing edge of the first side image is normally cropped first, followed by cropping the leading edge of the next, second side, image. By reducing the time required to read the image data 34, the time taken to crop the second side image can be safely less than the inter-page gap. When the second side of the paper arrives to be printed, the print data will thus be available at the marking engine, avoiding a potential fault.

To enable the DMA controller 20 to perform the functions described herein a conventional DMA controller, which is designed to operate independently of the crop component, can be programmed with additional operating instructions in the DMA read component 52. In particular, the DMA controller may be programmed to receive instructions from the crop component 22, such as the crop start and end instructions 90,92 and to act on them as described above. In particular, the crop start instruction 90 is passed to the DMA controller 20, which overrides the conventional process of reading the full image and allows the DMA controller to skip forward in the image. After the data corresponding to the full cropped image is received, the DMA read operation is terminated before all the programmed image data is transferred. This can significantly reduce the amount of image data transferred and also frees up system resources.

The DMA controller 20 is generally initialized by software including setup parameters, such as the address of the data memory 36, the address of the crop component 22, the length of each block in bytes (e.g., 4 KB or 8 KB, or 16 KB), and whether the DMA controller should generate a processor interrupt once the block transfer is complete.

DMA operations may be performed in either burst or single-cycle mode. Some DMA controllers support both. In burst mode, the DMA controller keeps control of the data bus 16 until all the data for a given image block has been transferred. The DMA controller itself does no processing on this data. In single-cycle mode, the DMA controller 20 gives up control of the data bus 16 after each transfer of a word (byte). This minimizes the amount of time that the DMA controller keeps the host processor 42 from using the data bus, but it requires that the bus request/acknowledge sequence be performed for every transfer. This overhead can result in a drop in overall system throughput if a large amount of data needs to be transferred.

Some DMA controllers 20 have larger address registers than length registers. For example, a DMA controller with a 32-bit address register and a 16-bit length register can access a 4 GB memory space, but can only transfer 64 KB per block. In the case where DMA transfers of larger amounts of data are required, the DMA software may include instructions to subdivide the blocks.

While the DMA controller 20 is illustrated as being incorporated in a custom hardware device 14, separate from the host computing device 12, in other embodiments, it may be incorporated into the host computing device 12, e.g., on the same chip or otherwise integral with the host computing device 12.

As will be appreciated the system 10 may include one or more computing devices capable of executing instructions for performing the exemplary method described herein.

Memory 18,58, etc., in the system 10 may include any type of non-transitory computer readable medium such as random access memory (RAM), read only memory (ROM), magnetic disk or tape, optical disk, flash memory, or holographic memory. In one embodiment, the memory comprises a combination of random access memory and read only memory. In some embodiments, the host processor 12 and memory 18 may be combined in a single chip. Similarly, the DMA memory may include any type of non-transitory computer readable medium such as RAM, ROM, magnetic disk or tape, optical disk, flash memory, holographic memory, or combination thereof.

The network interfaces 80, 82, 84, 86 allow the host computing device 12 to communicate with other devices via a computer network, such as a local area network (LAN) or wide area network (WAN), or the internet, and may comprise a modulator/demodulator (MODEM) a router, a cable, and/or Ethernet port.

The host digital processor device 42, and that of the custom hardware device, can each be variously embodied, such as by a single-core processor, a dual-core processor (or more generally by a multiple-core processor), a configurable integrated circuit, a digital processor and cooperating math coprocessor, a digital controller, a or the like. The host processor 42, in addition to executing instructions for actuating the switch 44 and for performing image processing 78, may also control at least a part of the operation of the marking device 40.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

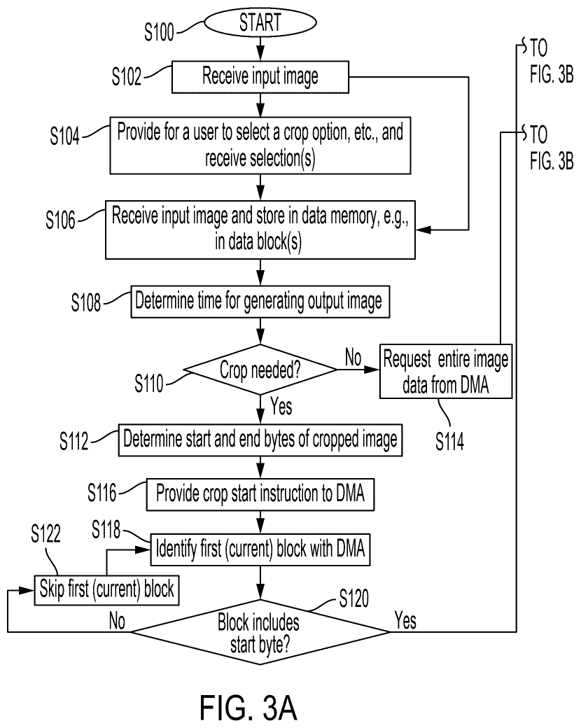

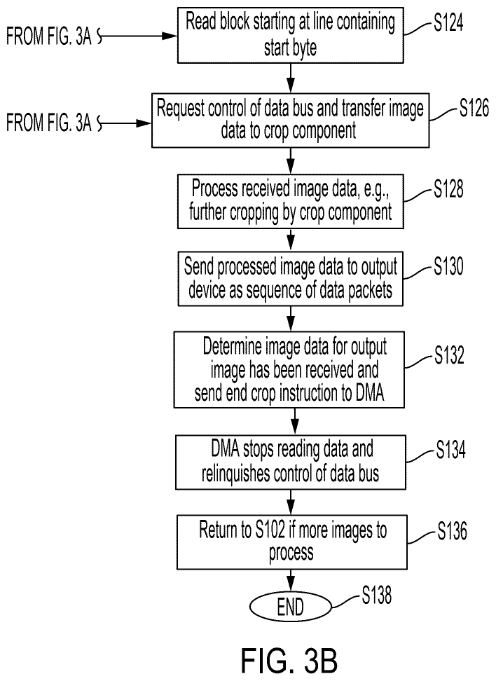

With reference to FIG. 3, which is split into FIGS. 3A and 3B for ease of illustration, a method of image cropping is described. The method begins at S100.

At S102, a source (input) image 28 to be processed, or a set of two or more images, is received from a source device 30,32. In the case of a scanned image, packets of source image data are received by the input interface device 24 and may be temporarily stored in the buffer 58, while being processed by the crop calibration component 54 and then written by the write DMA component 50 to the data memory 36. This may include the DMA controller calling on the host processor 42 to transfer control of the data bus 16 to the DMA controller for each packet of data transferred to data memory. In the case of a source device 32 which outputs an entire image 28, e.g., a PDF file, rather than small packets of data (a stream of pixels), the source image may be transferred by the host computing device 12 into data memory 36.

At S104, provision may be made for a user to select a crop option from a set of available crop options such as two or more of an automated crop option (autocrop), a manual crop option, and no crop., e.g., via the GUI 70. For example, the user may select the autocrop option. In another embodiment, the autocrop option may be a default option.

At S106, the source image 28 may be preprocessed, e.g., by the image processing component 78. This may include converting the image 28 to a raster format image (using raster image processing), if it is not already in that format, optionally performing image quality-related modifications to the source image, and partitioning the source image into one or more image data blocks 62 of the data memory 36, each block including a sequence of bytes of image data and being associated, e.g., in a list 64 in memory 36, with a descriptor defining the address and size of the block for each sequence of bytes.

At S108, the host computing device 12 is notified by the output (e.g., marking) device 40, or otherwise determines, that it is time to output the input image 28 to the output device and notifies the DMA controller when the processed input image is ready to read.

At S110, if the autocrop option has been selected by the user at S104, or by default, the X dimension of the input image 28 is determined and compared to the x dimension (e.g., of the print area) for the paper or other print media to be used in printing, e.g., by the crop implementation component 56. If at S110, the X dimension of the image 28 is determined to be larger than the x dimension of the print area of the paper in the process direction, the method proceeds to S112, otherwise to S114. If the autocrop option has not been selected, then another cropping method may be provided, if needed.

At S112, a location of a first byte or line of the raster image 28 which is to form the leading edge 104 of the output image 38 is identified, e.g., by the crop implementation component 56. For example, the crop component 22 may be preprogrammed to assume that the output image 38 will be centrally located in the input image 28 and may identify a location of the first line to be printed as being a distance of (XX−xx)/2 from the leading edge of image 28, where XX and xx may be expressed as numbers of lines of image data. The first byte nn to be read will then be at nn=(XX−xx)/(2×bb), where bb is the number of bytes in each line. The last byte pp which needs to be read may also be determined, e.g., as pp=nn+(xx×bb). As will be appreciated, nn and pp need not lie exactly on the leading and trailing edges 104,120, of the cropped image 38, allowing the crop component to perform a final cropping as needed.

At S116, the crop implementation component 56 calls on the read DMA component 52 to read the raster image 28 from data memory 36 and provides a crop start instruction 90, such as the location (e.g., the number nn) of the first byte to be read in the sequence of bytes.

At S118, if the input image 28 is stored in more than one block 106,108, etc., the DMA controller uses the list of descriptors 64 to identify the first block 106 of the input image 28. Otherwise, if the input image is stored in a single block, this step can be omitted.

At S120, the DMA controller checks the identified first block. If the first block ends prior to byte nn then at S122, the DMA controller does not read the first block, skipping to the next block by repeating step S118. If at S120, the identified first block (or current block), includes byte nn then the method proceeds to S124.

At S124, the read DMA component of the DMA controller identifies the line of bytes in the current block that begins with or otherwise includes byte nn and begins reading the sequence of bytes at that point. The DMA controller may proceed to read one or several blocks of data in this way, using the list of descriptors 48 to identify the next block to be read when the preceding block has been read.

At S126, the DMA controller requests control of the data bus 16 from the host processor 42 and sends the image data as it is read to the crop implementation component 56, in one or more bursts of data.

At S128, the crop implementation component 56 processes the received data, e.g., by cropping the lines of data in the cross-process direction, if needed.

At S130, the output device interface component 26 sends the output image 38, e.g., as a sequence of processed packets of image data, to the output device 40, which may print the image data on the print media 66, using the marking material.

At S132, when the crop component determines that byte pp has been processed, the crop implementation component sends a crop end signal 92 to the DMA controller to stop reading the image data 34.

At S134, when the read DMA component 52 receives the crop end signal 92, the read DMA component stops reading the image data 34 and at S134, relinquishes control of the data bus 16 to the host processor 42. As will be appreciated, when the DMA controller transfers the image data in multiple bursts, each subsequent burst may be initiated by requesting control of the data bus and then relinquishing control at the end of the burst.

At S136, the method may then return to S102 for processing of the next image in a sequence, if there is one, or proceed to S138 if all images have been processed.

The method ends at S138.

The method illustrated in FIG. 3 may be implemented in a computer program product or products that may be executed on one or more computing devices. The computer program product(s) may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product(s) may be integral with the controller 30 (for example, an internal hard drive of RAM), or may be separate (for example, an external hard drive operatively connected with the computing device), or may be separate and accessed via a digital data network such as a local area network (LAN) or the Internet (for example, as a redundant array of inexpensive or independent disks (RAID) or other network server storage that is indirectly accessed by the computing device, via a digital network).

The exemplary method may be implemented on one or more general purpose computers, special purpose computer(s), a programmed microprocessor or microcontroller and peripheral integrated circuit elements, an ASIC, or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device that is capable of implementing a finite state machine that is in turn capable of implementing the flowchart shown in FIG. 3, can be used to implement the method for cropping an image. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for processing an image comprising:
for an input image that is larger, in a process direction, than an output image to be generated from the input image, with a crop component, determining a first location within the input image corresponding to a first line of the output image to be generated;
providing the first location to a direct memory access (DMA) controller which is configured for reading image data of an input image from data memory starting at a provided location;
with the crop component, receiving image data read by the DMA controller from the data memory starting at the first location; and
generating the output image from the image data received.

2. The method of claim 1, wherein the input image is a raster image and the first location is identified as a byte within a sequence of bytes of the raster image.

3. The method of claim 1, wherein image data preceding the first location is not read by the DMA controller from the data memory.

4. The method of claim 1, further comprising:
with the crop component, determining a second location within the input image corresponding to a last line of the output image to be generated;
when the image data received by the crop component has reached the second location, signaling to the DMA controller to stop reading the image data from the data memory.

5. The method of claim 4, wherein at least some of the image data after the second location is not read from the data memory by the DMA controller.

6. The method of claim 1, further comprising, with a host processor, relinquishing control of a data bus to the DMA controller, the DMA controller thereafter transferring the image data read by the DMA controller via the data bus independently of the host processor.

7. The method of claim 1, wherein the crop component is configured for further cropping the image data read by the DMA controller to generate the output image.

8. The method of claim 1, wherein the input image is stored in a set of blocks in the data memory, each block being associated with a respective descriptor, and wherein the DMA controller is configured for identifying a sequence of the set of blocks to read, based on the descriptors.

9. The method of claim 8, wherein the DMA controller identifies a first of the blocks from the descriptors and, if the identified first location is not within the first block, proceeds to a second of the blocks without reading the first block.

10. The method of claim 8, wherein each of the descriptors comprises a starting byte and an ending byte of the image data stored in the respective block.

11. The method of claim 1, wherein the DMA controller and the crop component are located on a custom hardware device and the host processor is located on a host computing device, host computing device being linked to the custom hardware device by the data bus.

12. A printing system configured for performing the method of claim 1 and printing the output image.

13. A computer program product comprising a non-transitory recording medium storing instructions, which when executed on a computer, causes the computer to perform the method of claim 1.

14. An image processing system comprising:
data memory which stores an input image to be processed, the input image including image data;
a direct memory access (DMA) controller configured for reading the image data from the data memory;
a crop component which executes instructions for:
determining a first location in the input image, the first location corresponding to a first line of an output image to be generated from the input image, the output image being smaller, in a process direction, than the input image;
providing the first location to the DMA controller;
receiving image data read by the DMA controller from the data memory starting at the first location; and
generating the output image from the received image data.

15. The system of claim 14, wherein the input image is stored in a set of blocks in the data memory, each block being associated with a respective descriptor, and wherein the DMA controller is configured for identifying a sequence of the set of blocks to read, based on the descriptors.

16. The system of claim 14, wherein the DMA controller is configured for identifying a first of the blocks from the descriptors and, if the identified location is not within the first block, proceeding to a second of the blocks without reading the first block.

17. The system of claim 14, wherein the crop component executes instructions for determining a second location within the input image corresponding to a last line of the output image to be generated and wherein when the image data received from the DMA controller has reached the second location, signaling to the DMA controller to stop reading the image data from the data memory.

18. The system of claim 14, further comprising a graphical user interface which provides for a user to select a crop option from a plurality of crop options, the plurality of crop options including an automated crop option, wherein when the user selects the automated crop option, the host processor requests the crop component to crop the input image.

19. The system of claim 14, further comprising a marking device which prints the output image.

20. An image processing system comprising:
memory which receives an input image to be processed, the memory including a set of blocks, image data of the input image being partitioned into a plurality of the blocks, each of the blocks being associated, in memory, with an address which enables the image data within the block to be identified;
a crop component, which is configured for generating an output image from the input image;
a DMA controller configured for reading the image data in each of the blocks and transferring the read image data to the crop component, the DMA controller configured for implementing instructions from the crop component which cause the DMA to skip from a first of the blocks to a second of the blocks, without reading the image data in the first block; and
a marking device which receives the output image and renders the output image on a marking medium.
